(19) United States
(12) Patent Application Publication
(10) Pub. No.: US 2012/0261388 A1
(43) Pub. Date: Oct. 18, 2012

(54) SYSTEMS AND DEVICES FOR POWER COMMUTATION IN WELDING TORCHES

(75) Inventor: Stephen L. Anderson, Traverse City, MI (US)

(73) Assignee: Illinois Tool Works Inc., Glenview, IL (US)

(21) Appl. No.: 13/360,283

(22) Filed: Jan. 27, 2012

Related U.S. Application Data
(60) Provisional application No. 61/467,466, filed on Mar. 25, 2011.

(51) Int. Cl. B23K 9/00

(52) U.S. Cl. 219/74

(57) ABSTRACT

A welding torch includes an electrical commutation device configured to receive welding power. The electrical commutation device is also configured to transfer the welding power between a welding power input and welding wire before the welding wire passes through a guide device that directs the welding wire out of the welding torch.

### BACKGROUND

The invention relates generally to welding torches, and, more particularly, to systems and devices for power commutation in a welding torch.

Welding is a process that has become increasingly ubiquitous in various industries and applications. Such processes may be automated in certain contexts, although a large number of applications continue to exist for manual welding operations. In both cases, such welding operations rely on a variety of types of equipment to ensure that the supply of welding consumables (e.g., wire, shielding gas, etc.) is provided to the weld in an appropriate amount at the desired time. For example, metal inert gas (MIG) welding typically relies on a wire feeder to enable a welding wire to reach a welding torch. The wire is continuously fed during welding to provide filler metal. A power source ensures that arc heating is available to melt the filler metal and the underlying base metal.

In MIG welding applications, the wire feeder typically provides a continuous feed of welding wire so long as a trigger is actuated by the welding operator. The welding wire is fed through a contact tip that is surrounded by a nozzle. Generally, the contact tip provides an electrical path to allow welding power to flow between a welding power supply and the welding wire. During a welding application, spatter from melted welding wire may form on the contact tip of the welding torch. If there is sufficient spatter buildup, welding wire may jam within the contact tip. Likewise, erosion of or metal buildup in the bore of the contact tip caused by electrical arcing between the contact tip and the welding wire may cause loss of electrical contact or obstruction of the wire resulting in a burn back. When welding wire is jammed or burned back onto the end of the contact tip, actuating the trigger may cause bird nesting of the welding wire within the welding torch. Further, in certain configurations, the size of the nozzle surrounding the contact tip may inhibit the welding torch from reaching a desired welding location. As will be appreciated, the contact tip may become very hot during a welding application causing shielding gas to be superheated. As shielding gas is superheated, it becomes less dense which decreases the quality of the shielding during the welding application. Accordingly, there is a need in the field for techniques that might provide alternative torch configurations to overcome such deficiencies.

### BRIEF DESCRIPTION

In one embodiment, a welding torch includes a neck having conductive elements configured to receive welding power. The neck is configured to enable shielding gas and welding wire to pass therein. The welding torch also includes a conductive assembly electrically coupled to the conductive elements and configured to enable welding power to flow between the conductive elements and the welding wire. The welding torch includes a guide tip coupled to the neck and electrically insulated from the conductive assembly to inhibit welding power from passing through the guide tip. The guide tip is configured to direct welding wire to flow from the neck to a welding application.

In another embodiment, a welding device includes a guide tip including material that inhibits welding power from flowing through the guide tip. The guide tip may be substantially electrically non-conductive, thermally non-conductive, or some combination thereof.

In another embodiment, a welding torch includes a neck having a conductive portion and a passageway. The conductive portion is configured to enable welding power to flow to the welding operation, and the passageway is configured to enable welding wire to flow to the welding application. The welding torch also includes a wire guide device coupled to the neck and configured to allow welding wire to flow from the neck to the welding application. The wire guide device is configured to inhibit welding power from flowing through the wire guide device.

In another embodiment, a welding torch includes an electrical commutation device configured to receive welding power. The electrical commutation device is also configured to transfer the welding power between a welding power input and welding wire before the welding wire passes through a guide device that directs the welding wire out of the welding torch.

In another embodiment, a welding torch includes an electrical commutation device electrically coupled to a neck to receive welding power and configured to transfer welding power between the neck and welding wire. The welding torch also includes a guide device coupled to the neck and configured to be electrically isolated from the welding power. The guide device includes an electrically conductive material, a thermally conductive material, or some combination thereof.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of a welding power supply employing a welding torch with power commutation according to the present disclosure;

FIG. 2 is a break-away view of an embodiment of a portion of the welding torch of FIG. 1;

FIG. 3 is a cross-sectional view of an embodiment of a portion of the welding torch of FIG. 1;

FIG. 4 is a partial cross-sectional view of an embodiment of a conductive assembly of the welding torch of FIG. 3; and

FIG. 5 is a partial cross-sectional view of another embodiment of a conductive assembly of the welding torch of FIG. 3.

### DETAILED DESCRIPTION

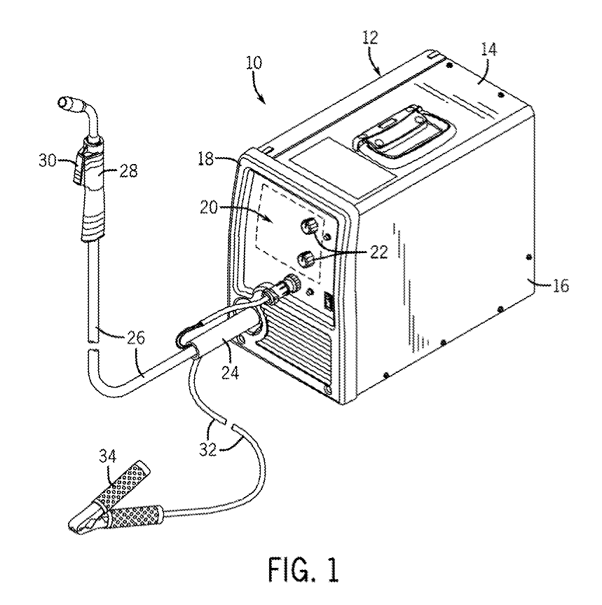

Turning now to the drawings, FIG. 1 is a perspective view of an exemplary welding power supply 10 configured for use in a gas metal arc welding (GMAW) process. The welding power supply 10 includes a housing 12 having a top panel 14, a side panel 16, and a front panel 18. The top panel 14 may include a handle that facilitates transport of the welding power supply 10 from one location to another by an operator if desired. The front panel 18 includes a control panel 20 adapted to allow an operator to set one or more parameters of the welding process, for example, via knobs 22 (or buttons, touchscreens, etc.).

In certain embodiments, the welding power supply 10 includes the functionality of a wire feeder (i.e., internal wire feeder). Such embodiments may include a wire drive configured to receive control signals to drive a wire spool. The wire drive feeds wire for the welding operation. In other embodiments, a separate wire feeder may attach to the welding power supply 10 (i.e., external wire feeder). Such a separate wire feeder may also include a wire drive and a wire spool.

A main electrical connector 24 couples to the welding power supply 10 via the front panel 18. A cable 26 extends from the main connector 24 to a welding torch 28 configured to be utilized in a welding operation to establish a welding arc. As will be appreciated, the welding torch 28 may include a conductive assembly that directs welding power through the welding wire so that welding power does not have to flow through a guide or contact tip of the torch 28. Further, in certain embodiments, the guide or contact tip may be manufactured from a material that inhibits welding power from flowing through the tip. For example, the contact or guide tip may be manufactured using a ceramic material, or another suitable material. As such, welding power may be transferred to welding wire using the conductive assembly rather than the guide or contact tip, resulting in reduced arc related deterioration of the guide or contact tip and reduced occurrence of burnbacks (e.g., where the welding wire fuses to the end of the guide or contact tip).

The welding torch 28 includes a trigger 30 that initiates a welding operation and causes welding wire to be supplied to the welding operation by exposing welding wire when pressed. Furthermore, pressing the trigger 30 may cause a switch in the trigger 30 to be actuated. In certain embodiments, wire may be supplied to a welding operation using a spoolgun attached to a welding power supply. In such configurations, the spoolgun may include a trigger to supply welding wire.

A second cable 32 is attached to the welding power supply 10 through an aperture in the front panel 18 and terminates in a clamp 34 that is adapted to clamp to the workpiece during a welding operation to close the circuit between the welding power supply 10, the welding torch 28, and the workpiece. During such an operation, the welding power supply 10 is configured to receive primary power from a primary power supply, such as a power source (e.g., the power grid, engine-generator, etc.), to condition such incoming power, and to output a weld power output appropriate for use in the welding operation. Further, the welding power supply 10 may be configured to receive shielding gas, such as from a gas supply cylinder.

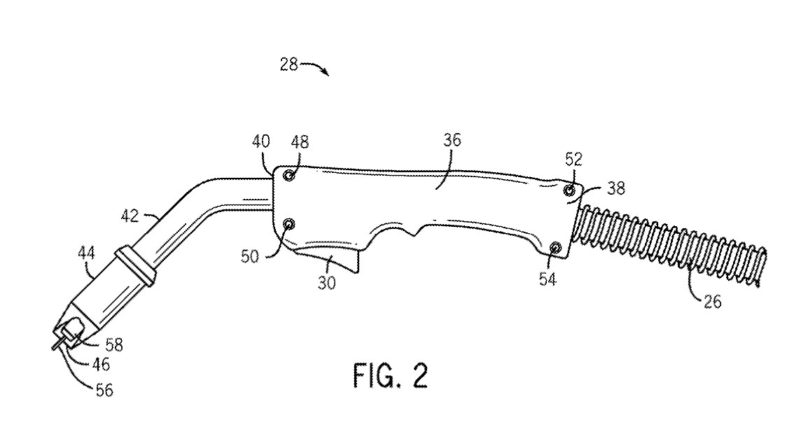

FIG. 2 is a break-away view of a portion of the welding torch 28 of FIG. 1. The welding torch 28 includes a handle 36 for a welding operator to hold while performing a weld. At one end 38, the handle 36 is coupled to the cable 26 where welding consumables are supplied to the weld. Welding consumables generally travel through the handle 36 and exit at an end 40, which is disposed on the handle 36 at an end opposite from end 38. The welding torch 28 includes a neck 42 extending out of the end 40. As such, the neck 42 is coupled between the handle 36 and a nozzle 44. As should be noted, when the trigger 30 is pressed or actuated, welding wire travels through the cable 26, the handle 36, the neck 42, and the nozzle 44, so that the welding wire extends out of an end 46 (i.e., torch tip) of the nozzle 44.

As illustrated, the handle 36 is secured to the neck 42 via fasteners 48 and 50, and to the cable 26 via fasteners 52 and 54. The nozzle 44 is illustrated with a portion of the nozzle 44 removed to show welding wire 56 extending out of a guide or contact tip 58 (or other guiding device). The guide tip 58 is used to guide the welding wire 56 out the end 46 of the welding torch 28. Welding power is commuted to the welding wire 56 using a conductive assembly within the neck 42 or another part of the welding torch 28. As such, power does not need to flow through the guide tip 58. Consequently, in certain embodiments, the guide tip 58 is constructed to inhibit welding power from flowing through the guide tip 58 (e.g., the guide tip 58 is generally electrically non-conductive) and/or the guide tip 58 is constructed to inhibit thermal energy from a welding application from being conducted through the guide tip 58 (e.g., the guide tip 58 is generally thermally non-conductive). For example, the guide tip 58 may be constructed using a ceramic based material, or another suitable (e.g., substantially electrically non-conductive and/or substantially thermally non-conductive) material. In certain embodiments, the material for constructing the guide tip 58 may include one or more of nitrides, borides, carbides, and oxides. For example, the guide tip 58 may be constructed using aluminum oxide, or zirconium oxide. Due to the composition of the guide tip 58, the guide tip 58 does not absorb as much heat as other contact tips, such as those constructed using copper. Because of lower temperatures in the guide tip 58, spatter buildup on the guide tip 58 is reduced and shielding gas superheating is inhibited, which results in more efficient welding operations. In other embodiments, the guide tip 58 comprises a generally conductive material (e.g., copper). In such embodiments, welding power is transferred between an electrical commutating device in the welding torch 28 and the welding wire 56 within the torch 28 prior to the welding wire 56 entering an opening within the guide tip 58. Further, the guide tip 58 is electrically insulated from the welding power circuit. Therefore, welding power does not flow through the material of the guide tip 58, resulting in less electrical arc related deterioration of the guide tip 58 and it eliminates the potential for burnbacks (where the welding wire fuses to the end of the guide tip 58).

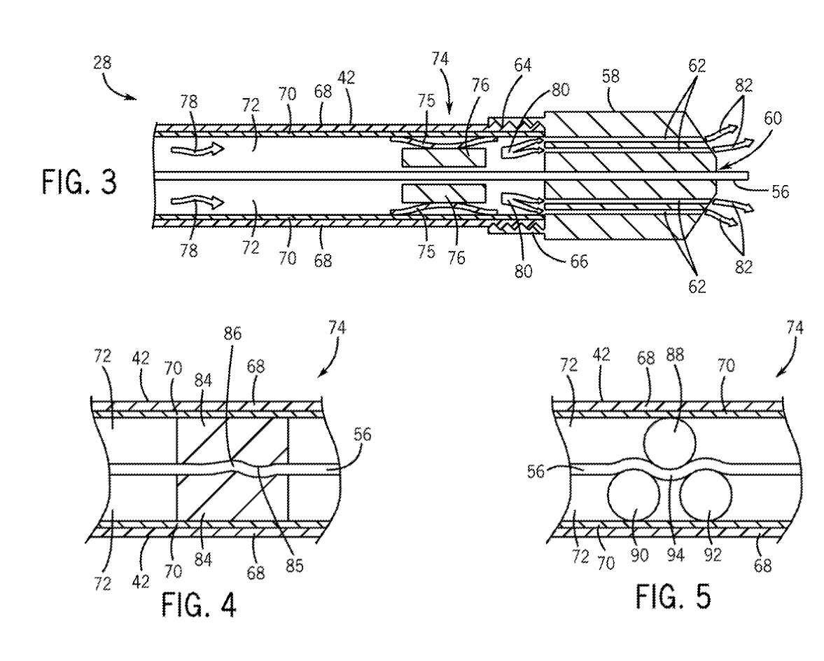

FIG. 3 is a cross-sectional view of an embodiment of a portion of the welding torch 28 of FIG. 1 using the guide tip 58. As illustrated, the guide tip 58 includes a central opening 60 (e.g., wire guide feature) to allow welding wire 56 to flow through the guide tip 58. Further, the guide tip 58 includes openings 62 that allow shielding gas to flow through the guide tip 58. Although four such openings 62 are depicted, the guide tip 58 may have any number of openings 62 that allow shielding gas to flow through the guide tip 58 (e.g., fewer or more than four openings). In the present embodiment, the guide tip 58 is coupled directly to the neck 42 of the welding torch 28. Specifically, a threaded end 64 of the neck 42 is inserted into the guide tip 58 and threadingly engaged with a threaded end 66 of the guide tip 58. The threads of the guide tip 58 are shown on the internal circumference of the threaded end 66 while the threads of the neck 42 are shown on the external circumference of the threaded end 64. However, in certain embodiments, the threads of the guide tip 58 may be on the external circumference of the threaded end 66 while the threads of the neck 42 may be on the internal circumference of the threaded end 64. In such an embodiment, the guide tip 58 is inserted into the neck 42 to threadingly engage the threaded ends 64 and 66. In other embodiments, the guide tip 58 may be connected to the neck 42 of the welding torch 28 by a set screw or any number of other clamping or holding methods or devices.

The welding torch 28 of the present embodiment does not include the nozzle 44 surrounding the guide tip 58. As such, the guide tip 58 may be used to perform welds in locations that are not accessible to embodiments using the nozzle 44. As will be appreciated, in embodiments where the nozzle 44 is used, the guide tip 58 may not have the openings 62 because shielding gas may flow around the outside of the guide tip 58 and within the nozzle 44. The guide tip 58 having opening 60 and/or openings 62 may be manufactured using any suitable manufacturing technique. For example, the guide tip 58 may be formed using a mold.

The neck 42 of the welding torch 28 may be constructed with an external layer 68 and an internal layer 70, both formed around an internal passageway 72. In certain embodiments the external layer 68 may be manufactured using an insulative material. The internal layer 70 is manufactured using a conductive material or conductive elements to allow welding power to flow therethrough. In certain embodiments, conductive elements are used instead of the internal layer 70. The internal passageway 72 provides a pathway for shielding gas to flow through the neck 42 to the guide tip 58.

A conductive assembly 74 (e.g., electrical commutating device) is electrically coupled to the internal layer 70 within the internal passageway 72. The conductive assembly 74 allows welding power to flow between the internal layer 70 and the welding wire 56. As such, the conductive assembly 74 may be formed in any suitable manner. For example, the conductive assembly 74 may be formed as illustrated in the present embodiment, as illustrated in FIG. 4, or as illustrated in FIG. 5. Further, the conductive assembly 74 may be formed using carbon brushes, carbon fiber brushes, wire brushes, wire fiber brushes, ionized gas plasma, and so forth. As discussed above, the conductive assembly 74 allows welding power to be transferred between the conductive assembly 74 in the welding torch 28 and the welding wire 56 within the torch 28 prior to the welding wire 56 entering the central opening 60 within the guide tip 58.

In the present embodiment, the conductive assembly 74 includes conductive springs 75 and conductive shoes 76 (e.g., carbon shoes). The conductive springs 75 press the conductive shoes 76 against the welding wire 56 with sufficient force to enable conduction between the conductive shoes 76 and the welding wire 56. However, the force between the conductive shoes 76 and the welding wire 56 does not inhibit the flow of welding wire 56 to a welding operation. Thus, welding power is transferred between the internal layer 70 and the welding wire 56 using the conductive assembly 74, thereby enabling the use of a non-conductive guide tip 58. As will be appreciated, by commutating power to the welding wire 56 using the conductive assembly 74, the purpose of the guide tip 58 may be limited to guiding welding wire 56 out the end of the welding torch 28. Therefore, in certain embodiments, the guide tip 58 may be replaced with any suitable device for guiding welding wire 56 out the end of the welding torch 28. For example, in certain embodiments, the guide tip 58 may be replaced with rollers, tubing, or any other type of guiding mechanism.

FIG. 4 is a partial cross-sectional view of an embodiment of the conductive assembly 74 of the welding torch 28 of FIG. 3. In this embodiment, a conductive cylinder 84 (e.g., carbon cylinder) with a jogged opening 75 is used to allow welding power to flow between the internal layer 70 and the welding wire 56. Specifically, 60847 the conductive cylinder 84 is inserted within the internal passageway 72 and maintains contact with the internal layer 70. The jogged opening 75 forces the welding wire 56 to include bends 86 which contact the conductive cylinder 84 at multiple locations and maintain conduction between the conductive cylinder 84 and the welding wire 56. Thus, welding power is transferred between the internal layer 70 and the welding wire 56 using the conductive assembly 74, thereby enabling the use of a non-conductive guide tip 58.

FIG. 5 is a partial cross-sectional view of another embodiment of the conductive assembly 74 of the welding torch 28 of FIG. 3. In this embodiment, conductive rollers 88, 90, and 92 are used to allow welding power to flow between the internal layer 70 and the welding wire 56. Specifically, the conductive rollers 88, 90, and 92 are inserted within the internal passageway 72 and maintain contact with the internal layer 70. The gaps between the conductive rollers 88, 90, and 92 force the welding wire 56 to include bends 94 which contact the conductive rollers 88, 90, and 92 and maintain conduction between the conductive rollers 88, 90, and 92 and the welding wire 56. Thus, welding power is transferred between the internal layer 70 and the welding wire 56 using the conductive rollers 88, 90, and 92, thereby enabling the use of a non-conductive guide tip 58. As will be appreciated, in certain embodiments, one or more of the rollers 88, 90, and 92 may be non-conductive; however, at least one of the rollers 88, 90, and 92 is conductive.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A welding torch comprising:
a neck having conductive elements configured to receive welding power, the neck configured to enable shielding gas and welding wire to pass therein;
a conductive assembly electrically coupled to the conductive elements and configured to enable welding power to flow between the conductive elements and the welding wire; and
a guide tip coupled to the neck and electrically insulated from the conductive assembly to inhibit welding power from passing through the guide tip, wherein the guide tip is configured to direct welding wire to flow from the neck to a welding application.

2. The welding torch of claim 1, wherein the conductive assembly comprises conductive springs electrically coupled to the conductive elements.

3. The welding torch of claim 2, wherein the conductive assembly comprises carbon shoes electrically coupled to the conductive springs and configured to enable welding power to flow between the conductive elements and the welding wire.

4. The welding torch of claim 1, wherein the guide tip comprises an opening configured to allow welding wire to flow through the opening.

5. The welding torch of claim 1, wherein the guide tip comprises a plurality of openings configured to allow shielding gas to flow therein.

6. The welding torch of claim 1, comprising a nozzle disposed around the guide tip.

7. The welding torch of claim 1, wherein the guide tip is configured to inhibit welding power from flowing through the guide tip.

8. A welding device comprising:
a guide tip comprising material that inhibits welding power from flowing through the guide tip.

9. The welding device of claim 8, wherein the material comprises a ceramic material.

10. The welding device of claim 8, wherein the guide tip is substantially electrically non-conductive, thermally non-conductive, or some combination thereof.

11. The welding device of claim 8, wherein the guide tip comprises a wire guide feature.

12. The welding device of claim 8, wherein the guide tip comprises a plurality of openings to allow shielding gas to flow through the guide tip.

13. The welding device of claim 8, comprising a neck coupled to the guide tip.

14. The welding device of claim 13, wherein the neck comprises conductive elements configured to enable welding power to flow between the neck and a welding wire.

15. The welding device of claim 8, comprising a nozzle disposed around the guide tip.

16. A welding torch comprising:
a neck comprising a conductive portion and a passageway, the conductive portion configured to enable welding power to flow to the welding operation, and the passageway configured to enable welding wire to flow to the welding application; and
a wire guide device coupled to the neck and configured to allow welding wire to flow from the neck to the welding application, the wire guide device configured to inhibit welding power from flowing through the wire guide device.

17. The welding torch of claim 16, wherein the wire guide device comprises a threaded end for coupling the wire guide device to the neck.

18. The welding torch of claim 16, wherein the wire guide device comprises a ceramic material.

19. The welding torch of claim 16, wherein the neck comprises conductive elements configured to enable welding power to flow between the conductive portion and the welding wire.

20. The welding torch of claim 16, comprising a nozzle disposed around the wire guide device.

21. A welding torch comprising:
an electrical commutation device configured to receive welding power and to transfer the welding power between a welding power input and welding wire before the welding wire passes through a guide device that directs the welding wire out of the welding torch.

22. A welding torch comprising:
an electrical commutation device electrically coupled to a neck to receive welding power and configured to transfer welding power between the neck and welding wire; and
a guide device coupled to the neck and configured to be electrically isolated from the welding power, the guide device comprising an electrically conductive material, a thermally conductive material, or some combination thereof.
